(19) United States
(12) Patent Application Publication
(10) Pub. No.: US 2023/0112292 A1
(43) Pub. Date: Apr. 13, 2023

(54) Pressing Device

(71) Applicant: Textor Maschinenbau GmbH, Wolfertschwenden (DE)

(72) Inventors: Fabian Müller, Betzigau (DE); Josef Mayer, Memmingerberg (DE); Matthias Hehle, Waltenhofen (DE); Markus Seidel, Egg an der Gunz (DE); Janik Böckenfeld, Kempten (DE)

(21) Appl. No.: 17/961,801

(22) Filed: Oct. 7, 2022

(30) Foreign Application Priority Data
Oct. 12, 2021 (DE) 102021126430.8

(51) Int. Cl. A22C 7/00; A22C 17/00

(52) U.S. Cl. CPC A22C 7/0023; A22C 17/0093

(57) ABSTRACT

A pressing device for pressing meat products, in particular frozen and/or partly frozen meat products, preferably fresh meat products and/or bacon, comprises a pressing chamber into which a product to be pressed can be inserted by an insertion device. The insertion device comprises a conveyor that is configured to convey the product transversely to a longitudinal direction of the pressing chamber to an insertion section, wherein the conveyor is supported at a housing of the pressing device, and wherein the conveyor is movable relative to the housing between an insertion position, in which the insertion section adjoins the conveyor, and an inactivity position in which the insertion section does not adjoin the conveyor.

### CROSS-REFERENCE TO RELATED APPLICATIONS

This patent application claims the priority of German Patent Application No. 10 2021 126 430.8, filed Oct. 12, 2021, which is incorporated herein by reference in its entirety.

The invention relates to a pressing device for pressing meat products, in particular frozen and/or partly frozen meat products, preferably fresh meat products and/or bacon.

Such pressing devices may be provided to compress meat products, which may in particular be present as natural products in an irregular shape, into a desired or required shape to be able to package the compressed meat products and offer them for sale or process them further. For example, provision may be made to cut off slices from the pressed meat products, for instance bacon pressed approximately into a parallelepiped shape, in a subsequent processing step by a slicing apparatus in order to form portions from the slices and to transfer these portions, for example, to a packaging machine arranged downstream and to package them by the latter. In particular in such a further processing, it may be desired to be able to produce slices of a desired and regular shape, for which purpose the upstream pressing may be necessary.

Thus, such pressing devices may in particular be provided as a component of a processing line for processing meat products, wherein the pressing may in particular represent one of the first processing steps. As a rule, such pressing devices have a pressing chamber which extends along a longitudinal direction and into which a product to be pressed has to be inserted before the pressing process. This insertion is usually provided manually so that a user has to insert the meat products to be pressed individually and successively into the pressing chamber.

Furthermore, provision may be made that a user has to close the pressing chamber prior to a pressing process in order to, for example, be able to reliably prevent an incautious manual intervention and a thereby resulting injury to a user during a pressing process. However, due to these steps that have to be performed manually before each pressing process, the desired throughput frequently may not be achieved.

It is generally also possible to provide an automatic loading of such a pressing device. The problem here is that the space available for the pressing device is usually limited, in particular in pressing devices that are provided as part of a processing line with further processing devices. In such processing lines, the further devices following the pressing device may adjoin the pressing device, in particular in the longitudinal direction, wherein a loading of the pressing device is, however, usually provided transversely to the longitudinal direction. For this purpose, it is again necessary to arrange a device for automatically inserting products transversely to the longitudinal direction, wherein the available space, however, has to be limited precisely in this direction and such a device may in particular also make it difficult to access the pressing device and/or the pressing chamber, for example, for maintenance or cleaning work. Therefore, a manual loading of pressing devices is usually preferred to an automatic loading despite the effort associated with a manual loading and the reduction of the throughput. Nevertheless, an automatic loading of the pressing device or an automatic insertion of products into a pressing chamber of a pressing device could facilitate the pressing process overall.

It is therefore an object of the invention to provide a pressing device for pressing meat products that enables an automatic or non-manual insertion of products into the pressing chamber without access to the pressing device thereby being made more difficult or the operation being disturbed.

This object is satisfied by a pressing device having the features of claim 1. The pressing device has a pressing chamber which extends along a longitudinal direction and into which a product to be pressed may be inserted by an insertion device. The insertion device comprises a first conveyor that is configured to convey the product transversely to the longitudinal direction of the pressing chamber to an insertion section. The first conveyor is further supported at a housing of the pressing device and is movable relative to the housing between an insertion position, in which the insertion section adjoins the first conveyor, and an inactivity position in which the insertion section does not adjoin the first conveyor.

Since in the pressing device disclosed herein an insertion device is provided by which a product to be inserted into the pressing chamber may be conveyed transversely to the longitudinal direction of the pressing chamber to an insertion section, an automatic insertion of the product into the pressing chamber may in particular take place. The insertion section may, for example, be arranged in the housing of the pressing device or be supported by the housing of the pressing device so that the products may so-to-say be insertable into the pressing device and/or a housing of the pressing device transversely to the longitudinal direction by the first conveyor. However, the insertion section may also be arranged in the pressing chamber so that the products may be directly insertable into the pressing chamber by the first conveyor of the insertion device.

For example, the first conveyor may comprise a conveyor band which revolves continuously and onto which the products may be placed by a user in order to be conveyed to the insertion section by the first conveyor. Thus, a user in particular does not have to reach in the pressing chamber to insert a product into the pressing chamber, but may, for example, place the product on the first conveyor, wherein the product may be inserted into the pressing chamber by the insertion device. The safety of the pressing device may also be increased in that, consequently, no manual intervention into the pressing chamber is required. The ergonomics of the operation of the pressing device may also be improved in that the first conveyor may at least sectionally, for example, be arranged lower than a pressing plane on which the products are disposed during the pressing in the pressing chamber so that the height at which a user has to lift the products may be reduced. For example, the first conveyor may be configured to move a placed product both transversely to the longitudinal direction, which may in particular extend along the horizontal, and vertically upwardly. The conveyor may in particular comprise a continuously revolving conveyor band that extends obliquely upwardly in the direction of the insertion section and/or one or more continuously revolving conveyor belts.

Since the first conveyor is further supported at a housing of the pressing device, the first conveyor may in particular be held in a defined position at the housing in the insertion position to be able to reliably convey the products to the insertion section that may in particular be arranged within the housing. In this respect, the first conveyor may in particular project transversely to the longitudinal direction of the pressing chamber from the housing to be able to convey and insert the products transversely to the longitudinal direction. Due to the possibility of moving the first conveyor supported at the housing into an inactivity position, access to the insertion section may be flexibly made possible in that the first conveyor does not adjoin the insertion section in the inactivity position and the insertion section is thus released for access. This may, for example, make it possible to clean the insertion section or to access the insertion section in order to perform maintenance work in this region of the pressing device.

The first conveyor may in particular be movable in such a manner that it is arranged in the inactivity position such that it does not project from the housing in that direction in which it projects in the insertion position. Such a moving away may, for example, also make it possible to unblock a passage along the pressing device, which passage the first conveyor may block or at least restrict in the inactivity position if a user would, for example at the side at which the first conveyor projects from the housing in the insertion position, like to move from a front side of the pressing device to a rear side of the pressing device.

The first conveyor thus makes it possible, on the one hand, to automatically convey products transversely to the longitudinal direction to the insertion section so that the products may be inserted into the pressing chamber by the insertion device. Due to the possibility of moving the first conveyor into the inactivity position, access to the insertion section may, however, be flexibly made possible at the same time and the first conveyor may so-to-say be moved out of the way so that an automatic insertion of products is made possible with a flexible use of space. Furthermore, the first conveyor may enable a plurality of products to be loaded onto the first conveyor that may be successively and automatically conveyed to the insertion section so that the first conveyor may also act as a buffer for products. The products may thereby enter the pressing chamber in a clocked manner, i.e. in a manner determined by the cycle time of the pressing device, without delays occurring due to a slowed-down manual loading of the pressing device or manual insertion of products into the pressing chamber.

Further embodiments can be seen from the dependent claims, the description, and the drawings.

In some embodiments, the insertion section may be arranged in alignment with the pressing chamber with respect to the longitudinal direction. Alternatively thereto, the insertion section may also be arranged in the pressing chamber in some embodiments.

The first conveyor may in particular be configured to convey the product transversely to the longitudinal direction up to an insertion section arranged in alignment with the pressing chamber so that the product may, for example, be pushed in the longitudinal direction into the pressing chamber, starting from the insertion section. For this purpose, the insertion device may, for example, have further conveyor, as will be explained in more detail below. However, provision may also be made that the insertion section is located directly in the pressing chamber so that the first conveyor may also be configured to convey products directly into the pressing chamber and thus to insert them.

Furthermore, the first conveyor may in particular also be supported at the housing in the inactivity position. Provision may thus be made that the first conveyor is not released from the housing when the first conveyor is moved from the insertion position into the inactivity position. Thus, the first conveyor does not have to be released from the housing to enable access to the insertion section or to release the space occupied in the insertion position, but may remain held at the housing. In this regard, the inactivity position may also be clearly defined and there may be a connection between the first conveyor and the housing in the inactivity position.

In some embodiments, the first conveyor may project transversely to the longitudinal direction from the housing in the insertion position. Furthermore, the first conveyor may be arranged behind the housing in the longitudinal direction in the inactivity position. As already explained, the conveyor may, due to an orientation transverse to the longitudinal direction, convey products placed onto the conveyor transversely to the longitudinal direction to the insertion section. The conveyor may in particular transport the products to the insertion section so that the products may, for example, be placed onto the insertion section by the first conveyor. Since the first conveyor may, however, be arranged behind the housing in the longitudinal direction in the inactivity position, access to the insertion section may be granted at the side at which the first conveyor projects from the housing in the insertion position. Such a side may in particular also be referred to as an operating side from which the products may be conveyed to the insertion section and from which, if necessary, other settings may, for example, also be made by a control device and/or a touchscreen. A switch cabinet may also be accessible from this side. A control device of the pressing device may, for example, comprise a microprocessor, a microchip, and/or a CPU.

While the arrangement of the first conveyor behind the housing in the longitudinal direction in the inactivity position in particular enables access to the insertion section for maintenance or cleaning work, this flexible arrangement of the first conveyor may also facilitate the transport of the pressing device. Such a movement of the first conveyor into the inactivity position enables a compact arrangement of the pressing device that primarily extends along the longitudinal extent when the first conveyor is in the inactivity position so that an extent transverse to the longitudinal direction may be minimized. When the first conveyor is inactive, the pressing device thus does not have an unnecessarily excessive width.

Furthermore, provision may, for example, be made that the first conveyor latches in at the housing in the inactivity position to secure the first conveyor in the inactivity position.

Since the first conveyor may be arranged behind the housing in the inactivity position, the pressing chamber, the insertion section, and the first conveyor may in particular be arranged behind one another in the longitudinal direction in the inactivity position. In the insertion position, on the other hand, the insertion section and the first conveyor may in particular be arranged at the same height with respect to the longitudinal direction so that the insertion section may directly adjoin the first conveyor.

The first conveyor may be pivotable between the insertion position and the inactivity position in some embodiments. The first conveyor may in particular be pivotable about a vertical pivot axis between the insertion position and the inactivity position.

The pivot axis about which the first conveyor may be pivoted may in particular be fastened to the housing and may, for example, be formed by vertically upwardly projecting pins or bolts onto which the first conveyor may be plugged. The first conveyor may in particular be hung in at the housing—in the manner of a door leaf or window leaf. The first conveyor may have a support strut, such as discussed in more detail below, and may be pivotably attached to the housing via this support strut. The first conveyor may, for example, be connected to such a pin or to the pivot axis via a pivot arm in particular to enable a pivoting behind the housing into the inactivity position and to bridge a spacing between the pivot axis and a rear side of the housing. The movement of the first conveyor may, but does not have to be a pure pivot movement. For example, the first conveyor may be pivotably attached to a rigid single-part pivot arm or a multi-part pivot arm that is movable in an articulated manner and that is itself pivotably attached to the housing. Alternatively thereto, the first conveyor may, for example, be displaceable between the insertion position and the inactivity position, for which purpose the first conveyor may, for example, be held in a guide at the housing. Irrespective of the kind of movement of the first conveyor between the insertion position and the inactivity position, provision may be made that the first conveyor latches in at the housing in the insertion position and/or the inactivity position so that both the insertion position and the inactivity position may be defined with respect to the housing and the conveyor may be secured against an unintentional release. For example, the first conveyor may latch in at the housing in the insertion position and in the inactivity position.

In some embodiments, the first conveyor may comprise a continuously revolving band. Furthermore, the first conveyor may comprise two deflection rollers and/or a tensioning device to deflect and, if necessary, to tension the continuously revolving band. The first conveyor may, for example, comprise a single revolving band or may comprise a plurality of belts and/or straps.

In some embodiments, the first conveyor may have a plurality of chambers, wherein at least one product may be insertable into each of the chambers. Due to the design with a plurality of chambers, the first conveyor may in particular act as a store and/or a buffer so that a plurality of products may be placeable onto the first conveyor and may be successively conveyed or transported to the insertion section. Possible delays due to a too slow manual loading of the pressing chamber may thereby in particular be prevented. For example, the first conveyor may comprise two, three, four, five, or six chambers. The chambers are preferably upwardly open.

In some embodiments, the chambers may be separated from one another by webs extending transversely to the conveying direction. The webs may in particular extend perpendicular to a direction along which the products move during the conveying to the insertion section to prevent a slipping of the products against this direction. This may in particular be provided when the products may both be movable transversely to the longitudinal direction of the pressing chamber by the first conveyor and may be raisable—in particular by moving along a slant—so that a slipping off of the products from the first conveyor may be prevented by the webs. Such webs may thus, for example, be provided in a first conveyor that comprises a band that revolves obliquely upwardly.

The chambers may, for example, be formed by respective continuous webs that extend continuously along the longitudinal direction over the first conveyor. Alternatively thereto, each web may also comprise a plurality of separate web sections so that the webs may so-to-say be interrupted in places. In particular in a configuration of the first conveyor with a continuously revolving band, the webs may further dip at a front deflection of the band in order to bridge a distance between the deflection and the insertion section and to support the products merely by moving into the insertion position onto the insertion section.

In some embodiments, the first conveyor may be supported at the housing via a support strut in the insertion position. The first conveyor may in particular be supported on the ground only via the housing in the insertion position.

Provision may thus be made that the conveyor does not have its own support on the ground, but is supported only via the housing. This may also enable a compact design of the pressing device and may furthermore facilitate the movement of the first conveyor from the insertion position into the inactivity position in that a support does not have to be pushed along the ground for this purpose. The support of the first conveyor via its support strut may in particular make it possible to transmit torques to the housing that are exerted by the products loaded onto the first conveyor. Such a support strut may in particular extend obliquely downwardly to the housing from an end section of the first conveyor that is spaced apart from the housing.

In some embodiments, the first conveyor may—at a transfer section facing the insertion section—have a sensor for detecting the product. The sensor may in particular be configured to detect a rear end of the product and thereby to detect when the product is transferred to the insertion section. A signal of the sensor may, for example, be transmitted to a control device of the pressing device, wherein this control device may be configured to stop a movement of the first conveyor when the sensor transmits such a signal and signals the transfer of a product to the insertion section. It may thereby be ensured that only a single product is arranged in the insertion section. However, the first conveyor may be driven again when the pressing process has been completed and/or the product has been conveyed from the insertion section into the pressing chamber.

The first conveyor may be lockable in the insertion position in some embodiments. Alternatively or additionally, in some embodiments, the first conveyor may have a detection device that is configured to detect the insertion position. Due to such a locking, it may in particular be ensured that the conveyor is securely held in the insertion position and is not unintentionally moved out of the insertion position. The configuration of the pressing device with a detection device may further serve to detect the correct arrangement of the first conveyor in the insertion position and to enable a driving of the first conveyor, for example, only when the first conveyor is in the insertion position. Faulty transfers of products from the first conveyor may thereby be avoided.

In some embodiments, a drive for driving the first conveyor may be arranged in the housing and the first conveyor may be configured to couple to a driven shaft, which is supported at the housing and which is driven by the drive, as a result of a movement from the inactivity position into the insertion position.

Thus, provision may be made that a drive for the first conveyor is directly supported at the housing so that no separate drive has to be arranged at the first conveyor. The drive may be configured to drive the driven shaft that is supported at the housing as well and in particular to set the driven shaft into rotation, wherein the driven shaft may, for example, be a motor shaft of the drive or a shaft connected to a motor shaft of the drive. Since the first conveyor is configured to couple to the driven shaft as a result of a movement into the insertion position, the first conveyor may be driven directly by the drive arranged in the housing, such that, for example, no components extending outside the housing, such as electrical lines, belts, etc., are required for driving the first conveyor. Furthermore, the first conveyor does not have to be specifically supplied with power. A compact and clear design of the pressing device may thereby also be achieved in that such external drive components and/or power connections may be omitted. Rather, the first conveyor may flexibly and selectively be coupled to the drive or connected to the drive in a purely mechanical manner merely by moving into the insertion position in order to enable an automatic insertion of products into the pressing device.

In some embodiments, the first conveyor may have a drive part that may be configured to enter into a rotationally fixed connection with the driven shaft as a result of the movement of the first conveyor from the inactivity position into the insertion position. The movement into the insertion position that is anyway required may therefore be used to simultaneously establish a drive-effective connection. The drive shaft of the conveyor may in particular be connected to a deflection roller of a continuously revolving conveyor band and/or may be formed by such a deflection roller. Since the drive shaft may automatically enter into a rotationally fixed connection with the driven shaft as a result of a movement of the first conveyor from the inactivity position into the insertion position, the drive shaft may be driven directly by the drive without requiring further steps for the connection. A drive arranged externally with respect to the housing for driving the first conveyor or any cable connections for an electrical power supply or for a technical signal control may also be omitted.

In some embodiments, the drive shaft and the driven shaft may be arranged coaxially to one another in the insertion position of the first conveyor. The drive shaft and the driven shaft may in particular be directly connected to one another in the insertion position of the first conveyor so that a rotation of the driven shaft may be directly transmitted to the drive shaft. In such embodiments, no further components—apart from coupling elements that may be required—are therefore arranged between the drive shaft and the driven shaft, in particular no gear.

In some embodiments, a first coupling element may be arranged at the drive shaft and a second coupling element may be arranged at the driven shaft, wherein the first coupling element may be configured to come into engagement with the second coupling element as a result of the movement of the first conveyor from the inactivity position into the insertion position. It may in particular be achieved by this engagement that the drive shaft is rotationally fixedly coupled to the driven shaft. Due to the first coupling element and the second coupling element, the drive shaft and the driven shaft may furthermore in particular be directly connected to one another in the insertion position of the first conveyor and may be in direct engagement with one another so that a rotation of the driven shaft may be transmitted directly and with minimal losses to the drive shaft of the first conveyor.

In some embodiments, the first coupling element may have at least two axial coupling sets that engage into associated axial coupling recesses of the second coupling element in the insertion position. Alternatively thereto, provision may also be made that the first coupling element has at least two axial coupling recesses in which two axial coupling prolongations of the second coupling element engage in the insertion position. The first coupling element and the second coupling element may thus enter into a plug-in connection in the insertion position of the first conveyor so that a rotation of the driven shaft may be transmitted to the drive shaft via the coupling elements. The configuration of the coupling elements with at least two axial coupling prolongations and two axial coupling recesses may enable a reliable transmission of the rotation of the driven shaft to the drive shaft. The axial direction of the coupling prolongations and the coupling recesses may in particular relate to the orientation of the drive shaft and the driven shaft in the insertion position of the first conveyor.

The second coupling element may be arranged in a deflectable manner at the driven shaft in some embodiments. The second coupling element may in particular be radially and/or pivotably arranged in a deflectable manner at the driven shaft, in particular pivotably about at least one pivot axis oriented perpendicular to the driven shaft. Such a deflectable arrangement of the second coupling element may in particular enable an alignment and/or a correction when the first conveyor is moved from the inactivity position into the insertion position to enable a secure engagement of the first coupling element and the second coupling element. A tolerance compensation may in particular be achieved by such a deflectable arrangement.

To arrange the second coupling element in a deflectable manner at the driven shaft, the second coupling element may, for example, be elastic and/or resilient. The second coupling element may furthermore be held at the driven shaft via a spring. Furthermore, the first coupling element may be held in an axially deflectable manner at the drive shaft in some embodiments. For example, the first coupling element may be held in a spring-preloaded manner at the drive shaft. This may also enable a tolerance compensation during the movement of the first conveyor into the insertion position to be able to achieve a reliable rotationally fixed connection via the coupling elements.

In some embodiments, the second coupling element may be held in a gimballed manner at the driven shaft. Such a gimbal connection of the second coupling element to the driven shaft may also enable a deflection of the second coupling element when the first conveyor is transferred into the insertion position and the second coupling element is mechanically acted on by the first coupling element. A tolerance compensation may thereby in particular be achieved again.

In some embodiments, a second conveyor may be arranged in the insertion section and is configured to convey the product in the insertion section transversely to the longitudinal direction.

In some embodiments, the second conveyor may furthermore be drivable by the drive. Provision may thus be made that a single and thus a common drive is provided for driving both the first conveyor, which is movable between the insertion position and the inactivity position, and the second conveyor. The drive may thus be configured to drive both the first conveyor and the second conveyor. The second conveyor may in particular be arranged within the housing. Since the drive may be used to drive both the first conveyor and the second conveyor, a compact design of the pressing device may again be achieved without a separate drive for the first conveyor being required.

In some embodiments, the second conveyor may be drivable by a second driven shaft driven by the drive. The second driven shaft may in particular be aligned in parallel with the driven shaft already mentioned via which the first conveyor may be driven.

Furthermore, the second conveyor may be configured to move the product away from the first conveyor.

In some embodiments, the drive may be configured to set the driven shaft and the second driven shaft into rotation in mutually opposite rotations. A direction of rotation in which the driven shaft may be rotated by the drive may thus be opposite to a direction of rotation in which the second driven shaft may be driven by the drive. The drive may furthermore be switchable so that both the driven shaft and the second driven shaft may be drivable in different directions of rotation.

However, the driven shaft and the second driven shaft may always be settable into mutually opposite rotations.

In some embodiments, the first conveyor may be drivable in the insertion position by a rotation of a motor shaft in a first direction of rotation and may have a freewheel with respect to a rotation of the motor shaft in a second direction of rotation opposite the first direction of rotation. The second conveyor may further be drivable by a rotation of the motor shaft in the second direction of rotation and may have a freewheel with respect to a rotation of the motor shaft in the first direction of rotation.

The first conveyor and the second conveyor may thus be drivable by opposite rotations of the drive in some embodiments. Due to the configuration of the first conveyor and the second conveyor with a respective freewheel, it may thus be achieved that, on a rotation of the motor shaft in the first direction of rotation, only the first conveyor is driven, whereas the second conveyor is not driven. On a rotation of the motor shaft in the second direction of rotation, the second conveyor is, in contrast, driven, whereas the first conveyor does not experience a drive due to the freewheel. This, for example, makes it possible to convey a product to the insertion section by the first conveyor, wherein the second conveyor arranged in the insertion section is at rest until the conveying of the product to the insertion section by the first conveyor has been completed. As already explained, this may, for example, be detected by a sensor arranged at the first conveyor. As soon as the product is arranged in the insertion section, the drive may, in contrast, be switched over so that the product may now be moved in the insertion section by the second conveyor, whereas the first conveyor is at rest. The first conveyor may thereby be prevented from conveying a further product into the insertion section when a product is already arranged in the insertion section and is moved onward by the second conveyor.

In some embodiments, the drive may comprise an electric motor, in particular a servomotor. A configuration of the drive with a servomotor may in particular enable a precise process control and a rapid switching over in order to, for example, enable the above-explained consecutive driving of the first conveyor and the second conveyor by the common drive.

In some embodiments, the drive may be configured to drive the driven shaft and the second driven shaft via a belt.

The belt may further be transferred via a deflection roller in some embodiments. The driven shaft, the second driven shaft, the deflection roller, and the motor shaft already mentioned may in particular be connected to one another via the belt in some embodiments. Such a connection of the driven shaft and the second driven shaft via a belt may furthermore enable the above-explained driving of the driven shaft and the second driven shaft in opposite directions of rotation in a simple manner in order to, for example, enable the above-explained conveying of a product by the first conveyor into the insertion section when the second conveyor is at rest and the subsequent conveying of the product by the second conveyor when the first conveyor is at rest. The belt may, for example, be configured as a band and/or as a strap.

In some embodiments, the second conveyor may be configured to convey the product in the insertion section against an abutment. It may thereby in particular be achieved that the product may be positioned in a predefined position in the insertion section in order to, for example, enable a subsequent correct insertion into the pressing chamber. The abutment may, for example, be formed from a metal sheet against which the product may be pushed by the second conveyor. Furthermore, the abutment may in particular be arranged opposite the first conveyor transversely to the longitudinal direction.

In some embodiments, the insertion device may have a third conveyor that may be configured to convey the product from the insertion section along the longitudinal direction into the pressing chamber. The insertion section may in particular be oriented in alignment with the pressing chamber with respect to the longitudinal direction for this purpose so that the product may be conveyable from the insertion section into the pressing chamber by a linear movement along the longitudinal direction. Furthermore, the product may for this purpose be conveyable in the insertion section against an abutment by the insertion device, in particular the aforementioned second conveyor, so that the product may be arranged in alignment with the pressing chamber with respect to the longitudinal direction in the insertion section.

The insertion of the product into the pressing chamber by the insertion device may thus firstly comprise conveying the product transversely to the longitudinal direction by the first conveyor to the insertion section, wherein the product may then be conveyable along the longitudinal direction into the pressing chamber by the third conveyor. If necessary, provision may furthermore be made that, after the conveying into the insertion section, the product is conveyed transversely to the longitudinal direction by a second conveyor arranged in the insertion section. The product may in particular be conveyed transversely to the longitudinal direction against an abutment by the second conveyor. Thus, a respective desired orientation of the product transverse to the longitudinal direction may be ensured by the second conveyor so that the third conveyor may act on a respective correctly oriented product.

In some embodiments, the third conveyor may be configured as a product pusher. For example, such a product pusher may engage at an end of the product facing away from the pressing chamber to push the product into the pressing chamber. For this purpose, the product pusher may have a pushing surface, for example.

However, it is also possible for the product pusher to have a gripper to engage into the product end. The product pusher may, for example, be guided in a guide extending along the longitudinal direction and may be drivable by a drive. Furthermore, the product pusher may be movable between two end positions to be able to convey a product from the insertion section into the pressing chamber, but then to be able to be moved back again to be able to insert a product subsequently conveyed into the insertion section into the pressing chamber again. The product pusher may, for example, be drivable by a spindle drive and/or an electric motor may be provided for driving the product pusher.

In some embodiments, the pressing chamber may have a pressing member that is movable in the longitudinal direction and that may be moved in the direction of a counter-element in order to compress the product in the pressing chamber, wherein the third conveyor may be configured to convey the product across the pressing member into the pressing chamber.

Furthermore, in some embodiments, the pressing chamber may comprise a first pressing member that is movable along the longitudinal direction in the direction of a first counter-element, a second pressing member that is movable horizontally and transversely to the longitudinal direction in the direction of a second counter-element, and a third pressing member that is movable along the vertical direction of a third counter-element. The third counter-element may in particular be formed by a pressing plane on which the product is disposed in the pressing chamber. In such embodiments, the product may thus in particular be pressed along the three spatial directions in order to, for example, be able to press a piece of bacon into a parallelepiped shape. The longitudinal direction may in particular be defined by a direction in which the pressing chamber has the greatest extent. Furthermore, the longitudinal direction may extend in the horizontal.

As regards possible dimensions of the pressing device, in particular in accordance with the possible embodiments explained above and/or in accordance with the embodiment described in more detail below with reference to the Figures, the pressing device may have one or more of the following features, wherein these features, unless otherwise stated, may in particular be implemented in those embodiments of a pressing device that serve for pressing bacon:

The pressing device may be designed for maximum product dimensions with a product width of approximately 350 mm extending perpendicular to the longitudinal direction, a product length of approximately 800 mm extending in parallel with the longitudinal direction, and a product height of approximately 150 mm.

As regards the external dimensions of the pressing device, it may have a width of approximately 100 cm and a length of approximately 270 cm. A width of approximately 100 cm, which is comparatively narrow, may in particular be achieved by the kind of drive disclosed herein for the pressing member movable in the direction of the width and it may also be advantageous in another aspect, in particular an aesthetic aspect, namely in particular when other components of a processing line have at least approximately the same width. Known bacon slicers, for example, likewise have a width of approximately 100 cm so that the pressing device disclosed herein may optimally fit into a corresponding processing line. The pressing device may also be implemented with a width of up to approximately 130 cm to 140 cm to be able to compress wider products, such as may, for instance, be required for compressing bacon in the US market. A length of 270 cm is relatively small compared to known pressing devices having similar performances and for similar applications so that space may be saved in the longitudinal direction. The loading height, i.e. that height to which a user at least has to raise a product to be compressed in order to insert it into the pressing chamber of the pressing device, may be in the range of approximately 100 cm to 120 cm above the ground, in particular depending on the setting of vertically adjustable feet with which the pressing device stands on the ground. This relatively low loading height, which is ergonomically favorable and thus relieves the user, may also be achieved by the kind of drive disclosed herein for the pressing member movable in the direction of the width. This loading height may be defined by the upper side of a protective cover, in particular a pivotable and/or removable protective cover, for the pressing member movable in the direction of the width when the loading takes place across this protective cover.

The pressing member for compressing the products in the different directions may be adapted such that it may permanently withstand maximum loads as follows: compressing in the vertical direction: approximately 25 tons, i.e. approximately corresponds to a force of 250 kN; compressing in the longitudinal direction: approximately 4 tons, i.e. approximately corresponds to a force of 40 kN; compressing in the width direction, i.e. perpendicular to the longitudinal direction: approximately 8 tons, i.e. approximately corresponds to a force of 80 kN.

The invention will be explained in the following purely by way of example with reference to an embodiment and to the drawings.

There are shown:

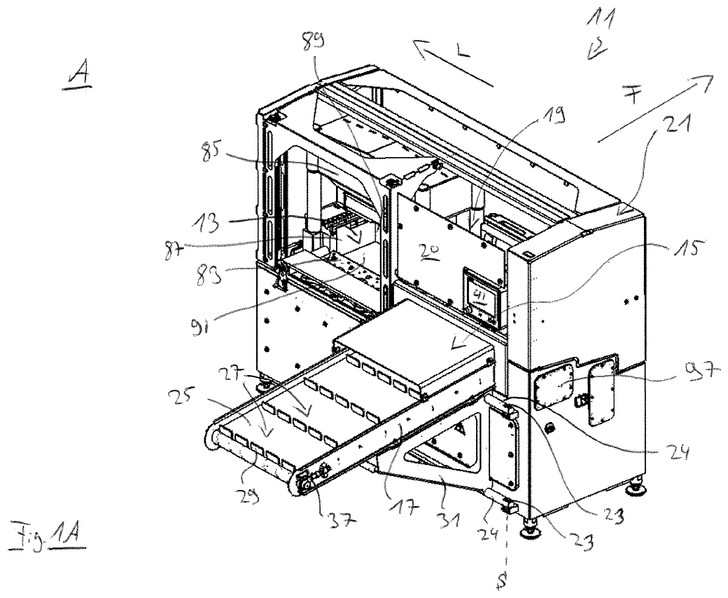

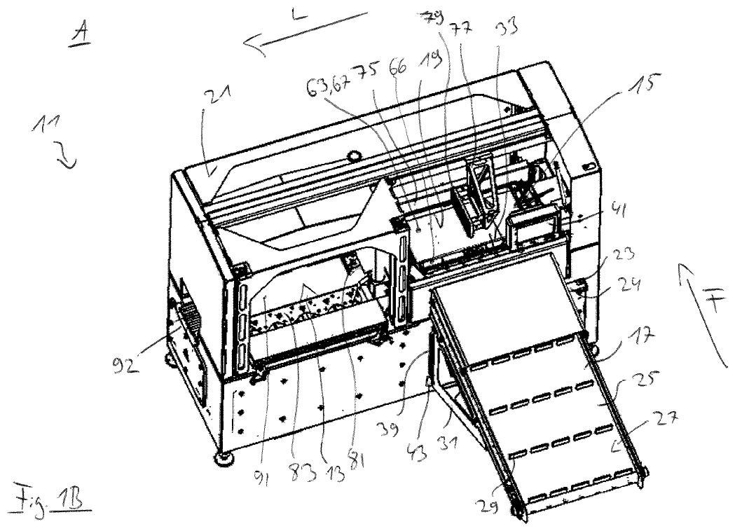

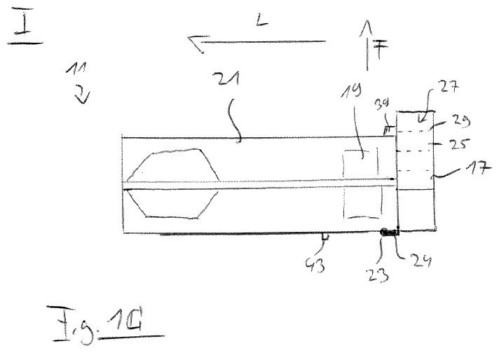

FIGS. 1A to 1C perspective views of a pressing device and a plan view of the pressing device;

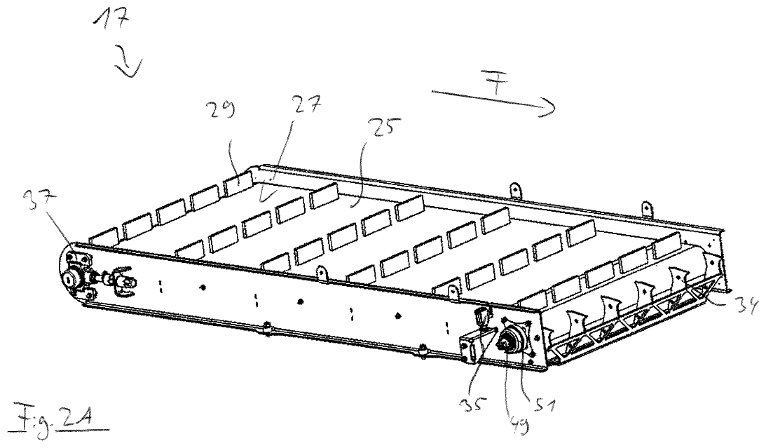

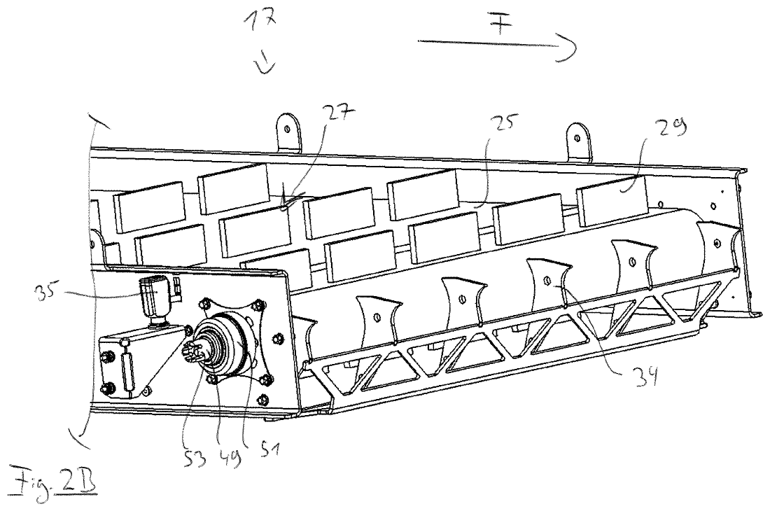

FIGS. 2A and 2B a perspective view and a perspective detailed view of a first conveyor of an insertion device of the pressing device for inserting products to be pressed into a pressing chamber;

FIG. 2C a longitudinal sectional representation of a front section of the first conveyor;

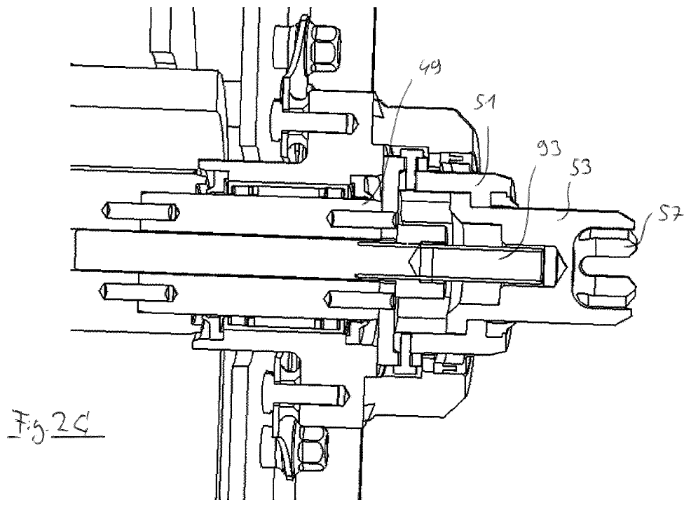

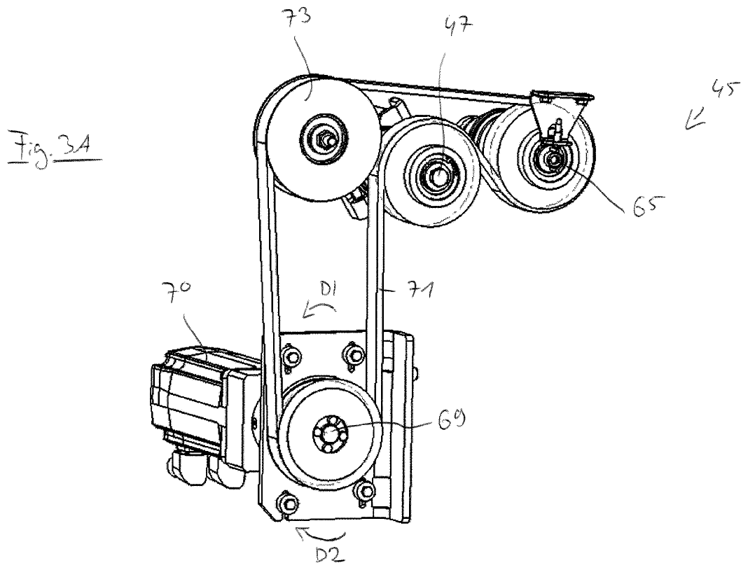

FIGS. 3A and 3B a perspective front view and a perspective rear view of a drive for driving the first conveyor; and

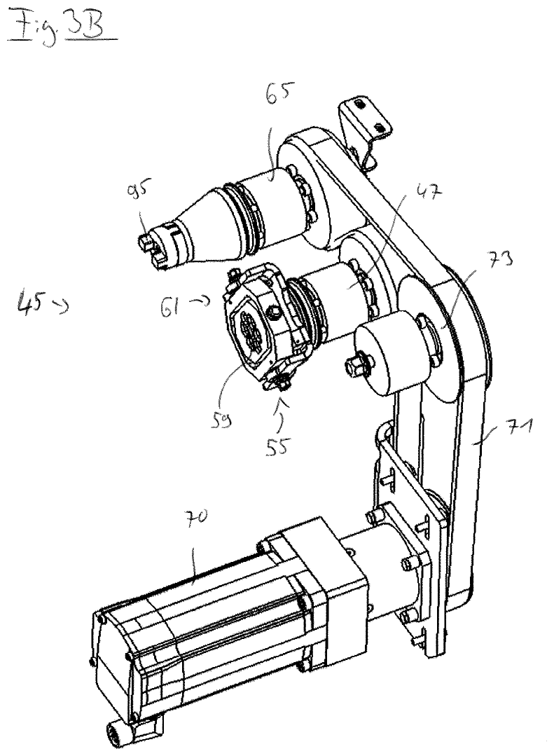

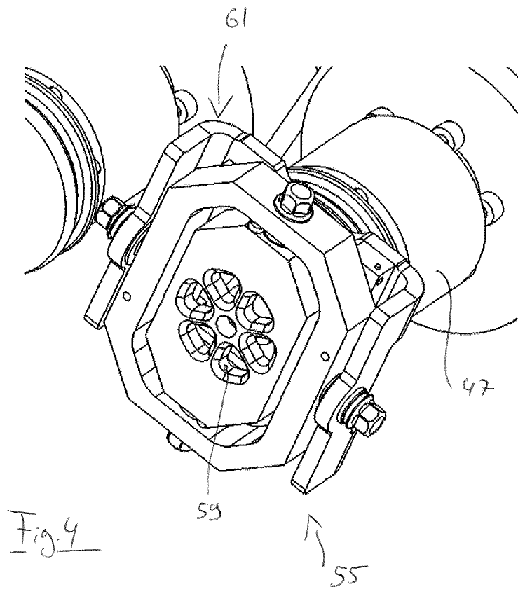

FIG. 4 a detailed view of a coupling element which is connected to a driven shaft drivable by the drive and via which the first conveyor may be connected to the drive.

FIG. 1A shows a pressing device 11 that is configured to compress meat products and in particular frozen and/or partly frozen meat products. For example, the pressing device 11 may be provided for pressing fresh meat products and/or bacon.

The pressing device 11 has a pressing chamber 13 which extends along a longitudinal direction L and into which a product, not shown, may be inserted for pressing. To be able to compress the product in the pressing chamber 13, the pressing chamber comprises a first pressing member 81 that is movable along the longitudinal direction L towards a first counter-element 87 to be able to compress the product in the longitudinal direction L. In this respect, the longitudinal direction L is in particular defined by that direction along which the pressing chamber 13 has the greatest extent. Furthermore, the longitudinal direction L may be oriented in the horizontal.

The pressing chamber 13 furthermore comprises a second movable pressing member 83 that is movable transversely to the longitudinal direction L and in the horizontal in the direction of a second counter-element 89. A product may consequently be compressed transversely to the longitudinal direction 11 by the second pressing member 83. Furthermore, the pressing chamber 13 comprises a third movable pressing member 85 that is movable vertically downwardly in the direction of a third counter-element 91 to be able to also compress a product in the vertical direction. The third counter-element 91 in particular forms a pressing plane on which a product is disposed during the pressing in the pressing chamber 13. Furthermore, the pressing chamber 13 has an output 92 through which a completely pressed product may be moved out of the pressing chamber 13 in the longitudinal direction L.

Such a pressing device 11 may thus be provided to compress meat products into a predefined and/or desired shape in order to, for example, package the compressed meat products and offer them for sale. For example, bacon pieces pressed into an approximately parallelepiped shape may be output by the pressing device and may then be offered for sale in this shape. However, provision may preferably be made that the pressing device 11 is provided as part of a processing line so that further apparatuses for processing meat products may be arranged downstream of the pressing device 11. For example, provision may be made to cut the products pressed by the pressing device 11 into slices by a slicing apparatus and to form portions from these slices that may then be transferred to a packaging machine and packaged portion-wise. In such a processing, provision may also be made to be able to cut off uniform slices from the product, wherein the slice shape may in particular be determined by a controlled pressing process.

In particular if the pressing device 11 is provided as part of a processing line, the duration required for processing the products may in particular depend on cycle times of the pressing device 11. To be able to press products by the pressing device 11, they, however, first have to be inserted into the pressing chamber 13, which usually takes place manually. However, this may slow down the process and, in a pressing process that may not have been properly stopped, there may furthermore be hazards for a user reaching into the pressing chamber 13.

To enable a safe and fast operation of the pressing device 11, the pressing device 11 illustrated in FIGS. 1A to 1C, in contrast, has an insertion device 15 that is configured to insert products into the pressing chamber 13. Thus, the products do not have to be manually inserted into the pressing chamber, but may be automatically moved into the pressing chamber 13 by the insertion device 15.

To enable an insertion of the products, the insertion device 15 has a first conveyor 17 that is configured to convey the products transversely to the longitudinal direction L of the pressing chamber 13 to an insertion section 19. In this respect, the first conveyor 17 comprises a conveyor band 25 and projects transversely to the longitudinal direction L away from a housing 21 of the pressing device 11.

The configuration of the insertion device 15 with such a first conveyor 17 projecting away from the housing 21 firstly enables a user not to have to insert the products directly into the pressing chamber 13, but to be able to place them onto the conveyor band 25. The first conveyor 17 has a plurality of upwardly open chambers 27 that are each configured in the manner of a compartment and that are separated from one another by webs 29, wherein at least one product may be inserted into each of the chambers 27. This may in particular enable a controlled conveying of the products and prevent a slipping off of the products when the products are conveyed along a conveying direction F that extends obliquely upwardly.

The first conveyor 17 is furthermore supported at the housing 21 via a support strut 31, but does not have its own support on the ground. Due to the support strut 31, torques that are transmitted to the first conveyor 17 by products loaded onto the conveyor band 25 may in particular be led off into the housing 21. Since the first conveyor 17 is not itself supported on the ground, a compact configuration of the pressing device 11 may be achieved.

As already explained, the first conveyor 17 is configured to convey products to an insertion section 19. As can be seen from FIG. 1B, in which the pressing device 11 is shown without a housing section 20, this insertion section 19 is arranged within the housing 21. The first conveyor 17 may thus in particular be configured to convey products transversely to the longitudinal direction L of the pressing chamber 13 and/or along a conveying direction F into the housing 21 of the pressing device 11.

A second conveyor 63 is arranged in the insertion section 19 and is configured to convey products arranged in the insertion section 19 further transversely to the longitudinal direction L of the pressing chamber 13. The second conveyor 63 is in particular configured as a band unit 67 and likewise comprises a conveyor band so that the second conveyor 63 may be inserted into the housing 21 of the pressing device 11 as a compact module in the form of the band unit 67.

The second conveyor 63 is furthermore configured to convey a product conveyed into the insertion section 19 transversely to the longitudinal direction L against an abutment 75. This may make it possible to precisely align the product in the insertion section 19 to enable a subsequent insertion into the pressing chamber 13.

In addition to the first conveyor 17 and the second conveyor 63, the insertion device 15 furthermore comprises a third conveyor 77 that is configured to convey a product from the insertion section 19 along the longitudinal direction L into the pressing chamber 13. In the embodiment shown, the third conveyor 77 is configured as a product pusher 79 that has a pushing surface and that is linearly displaceable in a guide along the longitudinal direction L. The product pusher 79 may thereby engage at an end of a product facing away from the pressing chamber 13 to push the product into the pressing chamber 13. Furthermore, to enable such a pushing of a product along the longitudinal direction L into the pressing chamber 13, the insertion section 19 is oriented in alignment with the pressing chamber 13 with respect to the longitudinal direction L. For example, the third conveyor 77 may be movable along the longitudinal direction L by a spindle drive and/or may be drivable by an electric motor, in particular a servomotor. Furthermore, it can be seen from FIG. 1B that the third conveyor 77 is configured to convey a product across the first pressing member 81 into the pressing chamber 13. The third conveyor 77 may furthermore also be movable against the longitudinal direction L to also be able to convey a product subsequently inserted into the insertion section 19 into the pressing chamber 13.

By the insertion device 15, products may thus be comfortably inserted into the pressing chamber 13 without a manual intervention into the pressing chamber 13 and/or a manual loading of the pressing device 11 being necessary. Rather, products may be comfortably inserted into the chambers 27 of the first conveyor 17 and may then automatically be successively guided into the pressing chamber 13 by the insertion device 15. Since the first conveyor 17 further has a plurality of chambers 27, the first conveyor 17 may also act as a store or a buffer for a plurality of products so that any delays due to a merely slow manual loading of the pressing chamber 13 may be avoided.

However, it can also be seen from FIGS. 1A and 1B that in an insertion position A, in which products may be conveyed to the insertion section 19 by the first conveyor 17 and the insertion section 19 adjoins the first conveyor 17 in the conveying direction F, the conveyor 17 projects transversely from the housing 21 and thereby for example impedes an access to the insertion section 19, for instance for cleaning or maintenance purposes. Furthermore, in this insertion position A, the first conveyor 17 projects into a path leading from the output 92 of the pressing chamber 13 to an opposite end of the pressing device 11 so that the first conveyor 17 may also impair a passage in this direction.

To, among others, address this problem and nevertheless enable a comfortable and automatic insertion of products into the pressing chamber 13, the first conveyor 17 is movable between the insertion position A shown in FIGS. 1A and 1B, in which the insertion section 19 adjoins the first conveyor 17, and an inactivity position I illustrated in FIG. 1C. In the inactivity position I, the first conveyor 17 is arranged behind the housing 21 of the pressing device 11 with respect to the longitudinal direction L so that the pressing chamber 13, the insertion section 19, and the first conveyor 17 are located behind one another with respect to the longitudinal direction L. In this inactivity position I, the first conveyor 17 thus does not project from the housing 21, but provides a passage and access to the insertion section 19.

In the embodiment shown, the first conveyor 17 may in particular be pivoted from the insertion position A into the inactivity position I—and vice versa. This enables a comfortable and quick change between the insertion position A and the inactivity position I. As FIG. 1C illustrates, the first conveyor 17 is, however, also connected to and supported at the housing 21 in the inactivity position I. Thus, the first conveyor 17 does not have to be separated from the housing 21 to enable access to the insertion section 19 or an undisturbed moving past the pressing device 11.

The first conveyor 17 is in particular pivotable about a pivot axis S that is formed by two pins 23 fastened to the housing and arranged vertically above one another at a spacing. The first conveyor 17 is connected to the pins 23 via respective pivot arms 24 to be able to bridge the spacing between the pins 23 and the end of the pressing device on a pivoting of the first conveyor from the insertion position A into the inactivity position I and to be able to arrange the first conveyor 17 behind the housing 21 in the inactivity position I.

Furthermore, it can be seen from FIGS. 1A to 1C that the first conveyor 17 does not have any supply lines, such as electric cables, and also does not have a drive arranged externally with respect to the housing 12 to enable a movement of products. Rather, the first conveyor 17 is configured to be driven by a drive 45 arranged behind a housing closure 97, as explained below with reference to FIGS. 2A to 4.

FIG. 2A shows a view of the first conveyor 17 and FIG. 2B shows a detailed view of an end of the first conveyor 17 facing the insertion section 19 in the insertion position A. The first conveyor 17, for example, has a tensioning device 37 to be able to tension the conveyor band 25. Furthermore, a sensor 35 is arranged at the end facing the insertion section 19 and is configured to detect a product in a transfer section between the first conveyor 17 and the insertion section 19. The sensor 35 may in particular be configured to detect a rear product end and to transmit a corresponding signal to a control device 41 of the pressing device (cf. FIGS. 1A and 1B), wherein the control device 41 may, for example, be configured to stop the first conveyor 17. A plurality of products may thereby be prevented from being simultaneously conveyed to the insertion section 19. In contrast, the control device 41 may be configured to drive the second conveyor 63 in response to a signal of the sensor 35 in order to enable a movement of the product in the insertion section 19 against the abutment 75.

FIGS. 2A and 2B furthermore show that a comb 34 is arranged at the housing 21, via which comb the products may be conveyed into the insertion section 19.

However, the interrupted webs 29 may dip between the comb 34 when the conveyor band 25 is moved onward. Furthermore, the webs 29 may serve as a support surface for the products during the transfer to the insertion section 19.

FIGS. 3A and 3B show the drive 45 already mentioned for the first conveyor 17 that is arranged in the housing 21 and that not is externally or directly arranged at the first conveyor 17. The drive 45 comprises a motor 70, in particular an electric motor and/or a servomotor, that is configured to set a motor shaft 69 into a rotation along a first direction of rotation D1 and along a second direction of rotation D2. The first direction of rotation D1 and the second direction of rotation D2 are opposite one another in this respect. The motor shaft 69 is connected to a driven shaft 47 and to a further driven shaft 65 via a belt. The belt furthermore runs around a deflection 73.

Due to the connection of the driven shaft 47 and the second driven shaft 65 to the motor shaft 69 via the belt 63, it may be achieved that the driven shaft 47 and the second driven shaft 65 always rotate oppositely to one another. Thus, the driven shaft 47 always rotates along the same direction of rotation D1 or D2 as the motor shaft 69, while the second driven shaft 65 always rotates in the opposite direction.

As FIG. 3B shows, a coupling element 55 is arranged at the driven shaft 47. The coupling element 55 is in particular connected to the driven shaft 47 via a gimbal holder 61 and has a plurality of axial coupling recesses.

As FIGS. 2A to 2C show again, a first coupling element 53, which has a plurality of axial coupling prolongations, is arranged at the drive shaft 49 of the first conveyor 17. The first coupling element 53 is in this respect configured to engage at the second coupling element 55 of the driven shaft 47 as a result of a movement of the first conveyor 17 into the insertion position. Consequently, as a result of a movement into the insertion position, the drive shaft 49 of the first conveyor 17 may automatically enter into a rotationally fixed coupling with the driven shaft 47 to be able to be driven by the drive 45.

Since the second coupling element 55 is held in a gimballed manner at the driven shaft 47, a tolerance compensation may in particular be achieved in that the second coupling element 55 may be deflected with respect to the driven shaft 47. Furthermore, the first coupling element 53 may also be deflected at the drive shaft 49 of the first conveyor 17 in that the latter is axially preloaded by a spring 93.

As FIG. 3B further shows, a plug-in coupling 95 is formed at the second driven shaft 65. Said plug-in coupling 95 is provided to bring the second driven shaft 65 into a rotationally fixed coupling with a second drive shaft 66 by which the second conveyor 63 may be driven. Consequently, the drive 45 is configured to drive both the first conveyor 17 and the second conveyor 45.

Furthermore, the driven shaft 47 and the further driven shaft 65 always rotate in opposite directions of rotation D1 or D2 due to the guide belt 71. The first conveyor 17 further has a freewheel with respect to a rotation of the motor shaft 69 along the second direction of rotation D2 so that the first conveyor 17 or the conveyor band 25 is stationary during a rotation of the motor shaft along the second direction of rotation D2. The second conveyor 63, in contrast, has a freewheel with respect to a rotation of the motor shaft 69 along the first direction of rotation D1. The first conveyor 17 may be driven by a rotation of the motor shaft along the first direction of rotation D1 and the second conveyor 63 may be driven by a rotation of the motor shaft along the second direction of rotation D1.

This may make it possible to intentionally convey products into the insertion section 19 and against the abutment 75 by the common drive 45 in that the motor shaft 69 is first driven along the first direction of rotation D1 and the product is conveyed to the insertion section 19 by the first conveyor 17. However, as soon as the product reaches the insertion section 19, the motor shaft 69 may be driven in the second direction of rotation D2 so that the product may be conveyed against the abutment 75 by the second conveyor 63, but no further product is conveyed into the insertion section 19. As soon as the product has been conveyed into the pressing chamber 13 by the third conveyor 77 and the third conveyor 77 has been moved back against the longitudinal direction L again, the motor shaft 69 may be driven along the first direction of rotation D1 again in order to convey a subsequent product to the insertion section 19 by the first conveyor 17.

FIGS. 1A and 1B further show that a locking member 39 for the first conveyor 17 is provided at the housing 12 in the insertion position A. Such a locking member 39 is also provided in the inactivity position I, as FIG. 1C shows. The first conveyor 17 may thereby in particular be secured against unintentional movements.

The pressing device 11 further comprises a detection device 43 that is configured to detect the first conveyor 17 in the insertion position A. The detection device 43 may in particular be configured to report to the control device 41 when the first conveyor 17 is in the insertion position A. The control device 41 may, for example, be configured to drive the conveyor 17 by the drive 45 only when the detection device 43 reports that the first conveyor 17 is correctly located in the insertion position A. For this purpose, the detection device 43 may, for example, comprise a contact sensor.

### REFERENCE NUMERAL LIST

11 pressing device
13 pressing chamber
15 insertion device
17 first conveyor
19 insertion section
20 housing section
21 housing
23 pin
24 pivot arm
25 conveyor band
27 chamber
29 web
31 support strut
33 transfer section
34 comb
35 sensor
37 tensioning device
39 locking member
41 control device
43 detection device
45 drive
47 driven shaft
49 drive shaft
51 deflection roller
53 first coupling element
55 second coupling element
57 coupling prolongation
59 coupling recess
61 gimbal holder
63 second conveyor
65 second driven shaft
66 second drive shaft
67 band unit
69 motor shaft
70 motor
71 belt
73 deflection
75 abutment
77 third conveyor
79 product pusher
81 first pressing member
83 second pressing member
85 third pressing member
87 first counter-element
89 second counter-element
91 third counter-element
92 output
93 spring
95 plug-in coupling
97 housing closure
A insertion position
D1 first direction of rotation
D2 second direction of rotation
F conveying direction
I inactivity position
L longitudinal direction
S pivot axis

1.-30. (canceled)

31. A pressing device for pressing meat products,
comprising a pressing chamber which extends along a longitudinal direction and into which a product to be pressed can be inserted by an insertion device,
wherein the insertion device comprises a first conveyor that is configured to convey the product transversely to the longitudinal direction of the pressing chamber to an insertion section,
wherein the first conveyor is supported at a housing of the pressing device, and wherein the first conveyor is movable relative to the housing between an insertion position, in which the insertion section adjoins the first conveyor, and an inactivity position in which the insertion section does not adjoin the first conveyor.

32. A pressing device in accordance with claim 31,
wherein the insertion section is arranged in alignment with the pressing chamber with respect to the longitudinal direction or is arranged in the pressing chamber.

33. A pressing device in accordance with claim 31,
wherein the first conveyor projects transversely to the longitudinal direction from the housing in the insertion position.

34. A pressing device in accordance with claim 31,
wherein the first conveyor is arranged behind the housing in the longitudinal direction in the inactivity position.

35. A pressing device in accordance with claim 31,
wherein the first conveyor is pivotable between the insertion position and the inactivity position.

36. A pressing device in accordance with claim 31,
wherein the first conveyor has a plurality of chambers, wherein at least one product can be inserted into each of the chambers.

37. A pressing device in accordance with claim 31,
wherein the first conveyor is supported at the housing via a support strut in the insertion position.

38. A pressing device in accordance with claim 31,
wherein, at a transfer section facing the insertion section, the first conveyor has a sensor for detecting the product.

39. A pressing device in accordance with claim 31,
wherein the first conveyor is automatically lockable in the insertion position by moving the first conveyor from the inactivity position into the insertion position.

40. A pressing device in accordance with claim 31,
wherein the pressing device has a detection device that is configured to detect the first conveyor in the insertion position.

41. A pressing device in accordance with claim 31,
wherein a drive for driving the first conveyor is arranged in the housing, wherein the first conveyor is configured to couple to the drive as a result of a movement from the inactivity position into the insertion position.

42. A pressing device in accordance with claim 41,
wherein the first conveyor is configured to couple to a driven shaft, which is supported at the housing and which can be driven by the drive, as a result of a movement from the inactivity position into the insertion position.

43. A pressing device in accordance with claim 42,
wherein the first conveyor has a drive shaft, wherein the drive shaft is configured to enter into a rotationally fixed connection with the driven shaft as a result of the movement of the first conveyor from the inactivity position into the insertion position.

44. A pressing device in accordance with claim 43,
wherein a first coupling element is arranged at the drive shaft and wherein a second coupling element is arranged at the driven shaft, wherein the first coupling element is configured to come into engagement with the second coupling element as a result of the movement of the first conveyor from the inactivity position into the insertion position.

45. A pressing device in accordance with claim 44,
wherein the second coupling element is arranged in at least one of a deflectable manner or a gimballed manner at the driven shaft.

46. A pressing device in accordance with claim 41,
wherein a second conveyor is arranged in the insertion section and is configured to convey the product in the insertion section transversely to the longitudinal direction, wherein the second conveyor can be driven by the drive.

47. A pressing device in accordance with claim 46,
wherein, in the insertion position, the first conveyor can be driven by a rotation of a motor shaft in a first direction of rotation and has a freewheel with respect to a rotation of the motor shaft in a second direction of rotation opposite the first direction of rotation, wherein the second conveyor can be driven by a rotation of the motor shaft in the second direction of rotation and has a freewheel with respect to a rotation of the motor shaft in the first direction of rotation.

48. A pressing device in accordance with claim 46,
wherein the second conveyor can be driven by a second driven shaft driven by the drive,
wherein the drive is configured to set the driven shaft and the second driven shaft into opposite rotations.

49. A pressing device in accordance with claim 46,
wherein the second conveyor is configured to convey the product in the insertion section against an abutment.

50. A pressing device in accordance with claim 31,
wherein the pressing chamber has a pressing member that is movable in the longitudinal direction and that can be moved in the direction of a counter-element in order to compress the product in the pressing chamber, and wherein the insertion device has a third conveyor that is configured to convey the product from the insertion section along the longitudinal direction into the pressing chamber, wherein the third conveyor is configured to convey the product over the pressing member into the pressing chamber.
